(19) United States
(12) Patent Application Publication
(10) Pub. No.: US 2022/0063707 A1
(43) Pub. Date: Mar. 3, 2022

(54) Restoring-Torque-Generating Device for a Motor Vehicle

(71) Applicant: Joyson Safety Systems Germany GmbH, Aschaffenburg (DE)

(72) Inventor: Dieter Markfort, Berlin (DE)

(21) Appl. No.: 17/414,898

(22) PCT Filed: Dec. 17, 2019
(86) PCT No.: PCT/EP2019/085562

§ 371 Date: Jun. 16, 2021

(30) Foreign Application Priority Data
Dec. 17, 2018 (DE) 10 2018 132 465.0

(51) Int. Cl. B62D 5/00; B62D 6/00; G01L 5/22; G01B 7/30

(52) U.S. Cl. CPC B62D 5/006; G01B 7/30; G01L 5/221; B62D 6/00

(57) ABSTRACT

A restoring-torque-generating device for generating a torque which is directed counter to a rotation of a steering handle of a motor vehicle comprises a housing, a drive which is stationary in the housing, a transmission which is in engagement with the drive, and a shaft which is mounted in the housing and is connected to a component of the transmission for conjoint rotation. The shaft or the housing is designed to be connected to the steering handle for conjoint rotation, and the housing, the transmission and the shaft are designed to be mounted for rotation relative to the motor vehicle and about an axis of rotation of the shaft. According to the invention, the restoring-torque-generating device comprises at least one elastic element, the restoring-torque-generating device being designed to be supported in relation to the motor vehicle counter to a rotation about the axis of rotation of the shaft by interposition of the elastic element.

The invention relates to a restoring-torque-generating device for generating a torque which is directed counter to the rotation of a steering handle of a motor vehicle, in accordance with the preamble of claim 1. The invention furthermore relates to a steering device and a motor vehicle comprising such a restoring-torque-generating device.

Restoring-torque-generating devices are used in steer-by-wire steering systems in particular. There, they serve to generate a restoring torque which counteracts a torque generated by a vehicle driver via the steering handle. The generation of such a restoring torque is necessary since, in steer-by-wire steering systems, the vehicle wheels are mechanically decoupled from the steering handle. A desired steering angle input by the driver of the vehicle via the steering handle is in this case transmitted exclusively by electrical means to actuating units or actuators for steering the vehicle wheels. Forces acting on the wheels during a steering movement are therefore not transmitted to the steering handle.

In order nevertheless to impart to the driver a driving sensation similar to a conventional steering system, electronically controlled actuators, for example, in the form of electric motors for instance, are used to generate a restoring torque, which can be adapted in magnitude and direction to different conditions.

For the operation of a steer-by-wire steering system, it is absolutely essential to detect the steering torque exerted by a vehicle driver on the steering handle and the restoring torque acting on the steering handle.

For this purpose, DE 19914383 proposes a torque detection device positioned coaxially with the steering shaft. In this case, the torque is determined via the elastic deformation of a torsion bar. One disadvantage here is that the torque is measured on a rotating part. Torque sensors of this type are of complex construction and must be mounted in a complicated manner. They also presuppose a large installation space in the axial direction of the steering shaft. In addition, they require complex evaluation electronics and, as a result, are relatively expensive to produce or procure.

The problem on which the invention is based is that of creating a space-saving and simple way of determining torques acting during the operation of steer-by-wire steering systems.

This problem is solved by providing the restoring-torque-generating device having the features of claim 1. Further developments of the invention are specified in the dependent claims.

Accordingly, a restoring-torque-generating device for generating a torque which is directed counter to the rotation of a steering handle of a motor vehicle is made available. The restoring-torque-generating device comprises a housing, a drive, which is arranged in a fixed location in the housing or with respect to the housing, a transmission, which is in engagement with the drive, and a shaft, which is mounted in the housing and is connected to a component of the transmission for conjoint rotation therewith. The shaft or the housing is designed to be connected to the steering handle for conjoint rotation therewith, and the housing, the transmission and the shaft are designed for rotatable mounting with respect to the motor vehicle and about an axis of rotation of the shaft. The restoring-torque-generating device furthermore comprises at least one elastic element, wherein the restoring-torque-generating device is designed to be supported with respect to the motor vehicle against a rotation about the axis of rotation of the shaft with the interposition of the elastic element.

The restoring-torque-generating device can be designed for use in a steer-by-wire steering system.

The support with respect to the motor vehicle can be accomplished via the housing or the shaft.

The restoring-torque-generating device can comprise at least two stops for arrangement in a manner fixed with respect to the vehicle, which are designed to limit a rotation of the housing or of the shaft about the axis of rotation of the shaft. The stops can limit the rotation to less than a quarter of a revolution. In particular, the stops can limit the rotation to less than a fiftieth of a revolution. The stops can furthermore be designed to effect limitation of the rotation by contact with the elastic element.

The restoring-torque-generating device can furthermore comprise at least one stop element which is arranged for conjoint rotation with respect to the housing or the shaft and is designed to contact in each case one of the stops in order to limit the rotation.

The at least one elastic element may have a progressive force-displacement characteristic. When the steering handle is rotated from a central position in any direction, the force, in particular the restoring force of the at least one elastic element, can in this case increase disproportionately in relation to an extent of the rotation.

The transmission can be designed as a worm gear which comprises at least one worm shaft and at least one worm wheel.

The restoring-torque-generating device can comprise at least one damping element. In this case, the restoring-torque-generating device can be designed to be supported against a rotation about the axis of rotation of the shaft, furthermore with the interposition of the damping element.

The restoring-torque-generating device can comprise at least one sensor, which is designed for detecting a force and/or for detecting an angle of rotation about the axis of rotation of the shaft. At least one sensor of the restoring-torque-generating device can be designed to detect a force. In this case, the restoring-torque-generating device can be designed to be supported against a rotation about the axis of rotation of the shaft, furthermore with the interposition of the sensor. Here, the elastic element can be integrated in the sensor for detecting the force.

The restoring-torque-generating device can in particular comprise a plurality of sensors, of which at least one first sensor is designed for detecting a force and at least one second sensor is designed for detecting an angle of the rotation about the axis of rotation of the shaft.

At least one sensor of the restoring-torque-generating device can be acted upon via a lever arrangement. In this case, the at least one sensor can be designed for detecting an angle of rotation about the axis of rotation of the shaft. Moreover, the sensor can comprise at least one of a rotating angle sensor, an optical sensor, an eddy-current sensor and a magnetic sensor, which is designed for detecting a permanent or electrically generated magnetic field. At least one lever of the lever arrangement can be arranged for conjoint rotation with respect to the housing or the shaft. In addition or as an alternative to this, at least one lever of the lever arrangement can be embodied as a lever of the first class.

According to a further aspect, a steering device for arrangement in a motor vehicle is made available. The steering device comprises a restoring-torque-generating device of the type presented here, a steering handle, and a supporting element. The shaft or the housing of the restoring-torque-generating device is connected to the steering handle for conjoint rotation therewith, and the restoring-torque-generating device is designed to be supported with respect to the supporting element against a rotation about the axis of rotation of the shaft.

According to a further aspect, a motor vehicle is made available. The motor vehicle comprises a restoring-torque-generating device or a steering device of the respective types presented here.

The invention is explained in detail below by means of exemplary embodiments with reference to the figures, in which:

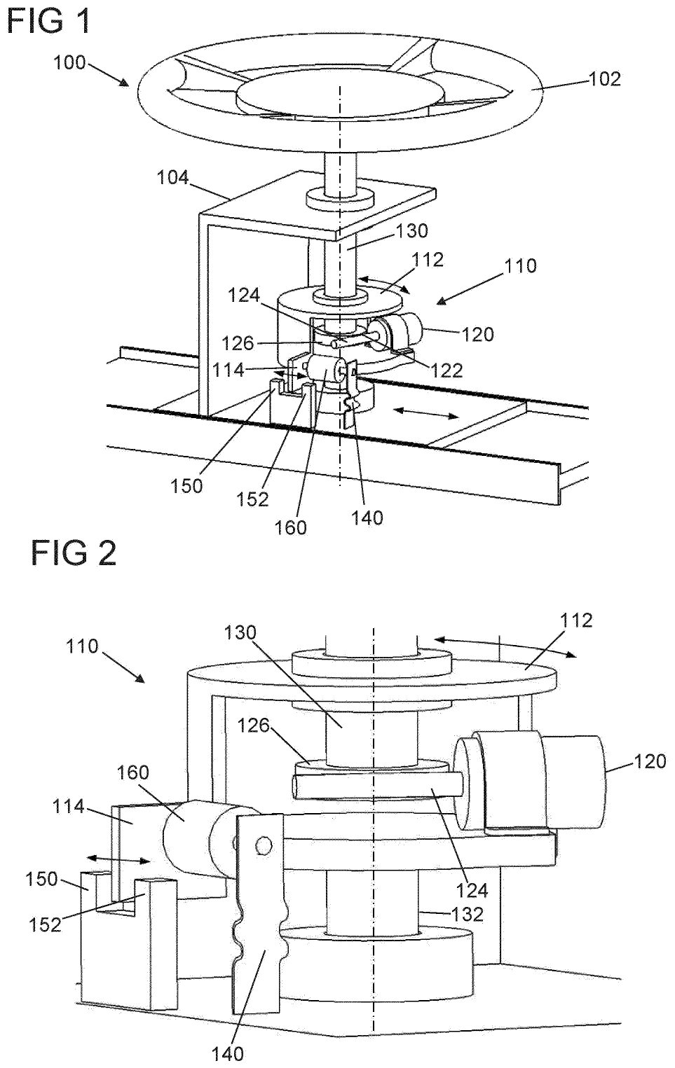

FIG. 1 shows a steering device having a restoring-torque-generating device according to one exemplary embodiment;

FIG. 2 shows a view of the restoring-torque-generating device of the steering device in FIG. 1;

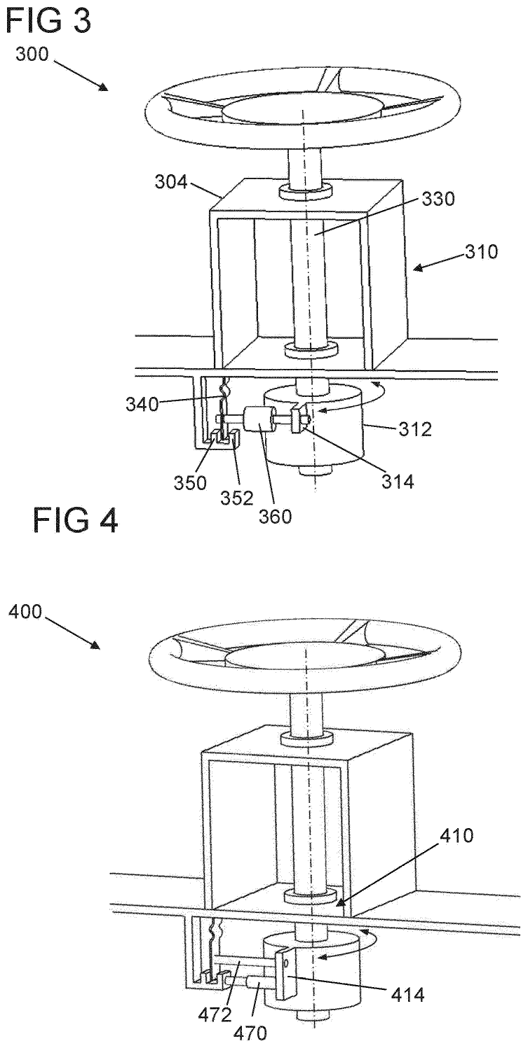

FIGS. 3 to 8 show steering devices each having a restoring-torque-generating device according to further exemplary embodiments;

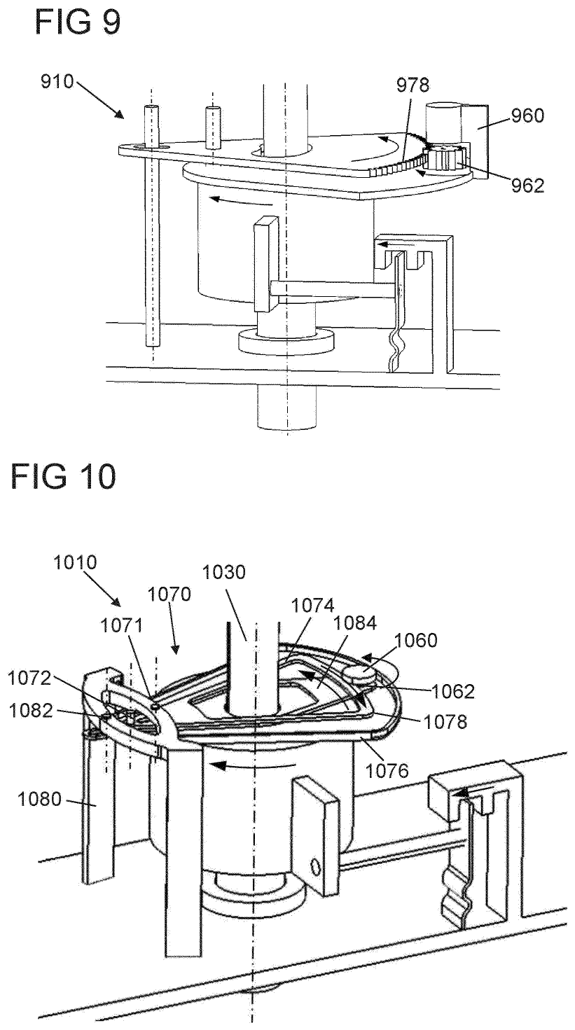

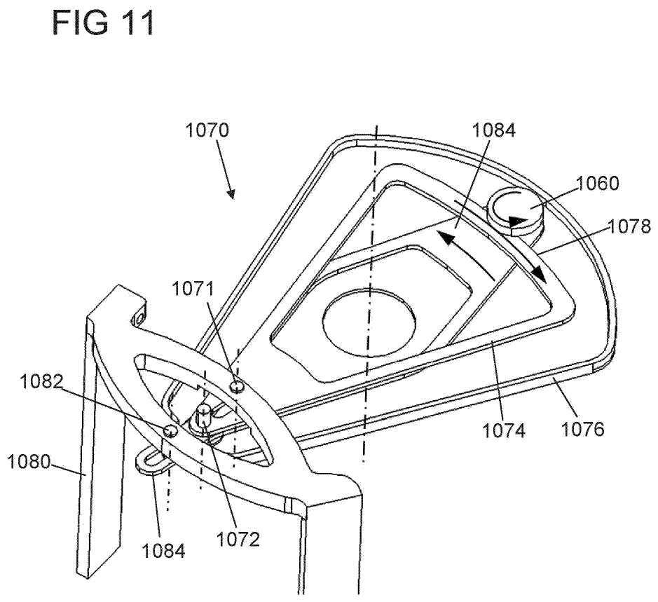

FIGS. 9 and 10 show restoring-torque-generating devices according to further exemplary embodiments;

FIG. 11 shows a view of a lever arrangement of the restoring-torque-generating device in FIG. 10; and

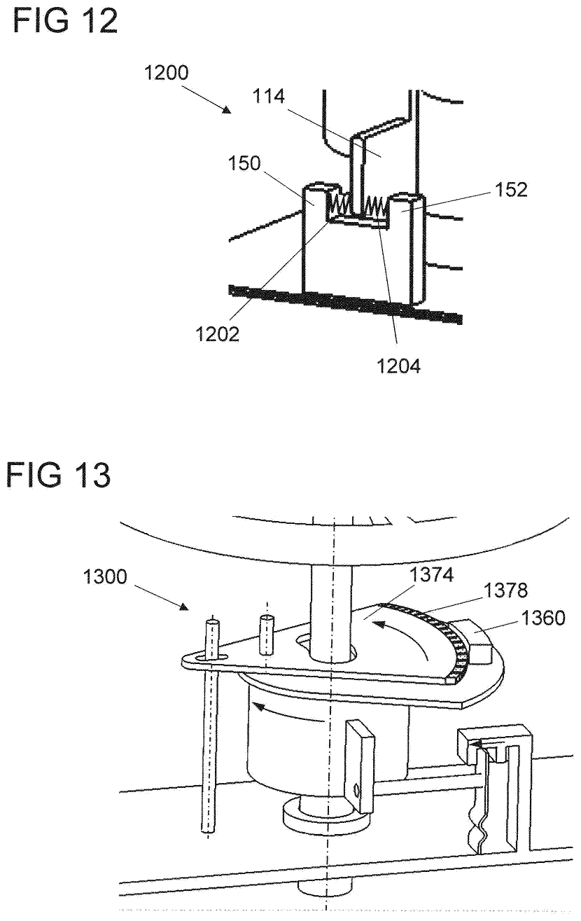

FIGS. 12 to 16 show steering devices according to further exemplary embodiments.

FIG. 1 shows schematically and by way of example a steering device 100 according to one example. The steering device 100 is provided for use in a steer-by-wire steering system, for example.

The steering device 100 comprises a steering handle 102. In the example shown, the steering handle 102 is configured as a steering wheel. The steering handle 102 is furthermore connected to the shaft 130, which in turn is part of a restoring-torque-generating device 110 of the steering device 100. The steering device 100 furthermore comprises a supporting element 104, on which the restoring-torque-generating device 110 and the steering handle 102 are mounted and which serves to support the restoring-torque-generating device 110 against steering torques or torques that may act on the shaft 130. In the example shown, the supporting element 104 is equipped with a carriage and is arranged slidably on a guideway fixed with respect to the vehicle.

The restoring-torque-generating device 110 furthermore comprises a housing 112, in which the shaft 130 is rotatably mounted. Also provided in the housing 112 is a drive 120, which is arranged in a fixed location with respect to the housing 112. Between the drive 120 and the shaft 130, a transmission 122 is furthermore provided, which is in engagement with the drive 120 and transmits a force generated by the drive 120 as a torque to the shaft 130.

In the example shown, the transmission 122 is designed as a worm gear which comprises a worm shaft 124 on the input side and a worm wheel 126 on the output side. The worm wheel 126 is attached to the shaft 130 for conjoint rotation therewith.

The construction described permits a torque generated by the drive 120 and the transmission 122 to be exerted on the shaft 130 in relation to the housing 112 and about an axis of rotation (shown by dashed lines) of the shaft 130. As a result of the connection of the steering handle 102 to the shaft 130 for conjoint rotation therewith, such a torque is additionally transmitted to the steering handle 102.

The shaft 130 is mounted in a support section of the supporting element 104 in such a way as to be rotatable relative to the supporting element 104. In this arrangement, a steering movement exerted, for example, by a driver on the steering handle 102 is transmitted to the housing 112 via the shaft 130, the transmission 122 and the drive 120 (double arrow above the housing 112). To limit such a rotation, the restoring-torque-generating device 110 comprises two stops 150, 152 which are arranged in fixed locations with respect to the supporting element 104, and a stop element 114 on the housing 112, which moves between the stops 150, 152 during a rotation of the housing 112 (double arrow on the stop element 114). In addition, the restoring-torque-generating device 110 is supported on the supporting element 104 via the elastic element 140 with respect to a rotation about the axis of rotation of the shaft 130. In this case, a force sensor 160 is arranged between the stop element 114 and the elastic element 140.

The construction shown makes it possible to detect a steering torque or torque acting on the shaft 130 relative to the supporting element 104 with the aid of the sensor 160. In this case, a signal from the force sensor 160 is used, for example, to determine a steering torque exerted by a driver on the steering handle 102 and to control the drive 120 on the basis of the determined steering torque in such a way that a suitable restoring torque is generated which counteracts the steering torque.

In some examples, an elasticity of the elastic element 140 is selected in such a way that, at customary steering torques, stop contact of the stop element 114 against one of the stops 150, 152 does not take place or at least only takes place in a greatly damped manner. Moreover, in some examples, the elastic element 140 has a progressive force-displacement characteristic. When the steering handle is rotated from a central position in any direction, the force increases disproportionately in this case. Furthermore, in some examples, the stops 150, 152 are arranged in such a way that they limit a rotation of the restoring-torque-generating device 110 about the axis of rotation of the shaft 130 to less than a quarter of a revolution, e.g. to less than a fifteenth of a revolution, in some examples for instance to less than a fiftieth of a revolution.

In the manner described, the steering device 100 permits the determination of a steering torque or the determination of a restoring torque using a simple sensor 160 based on the detection of a force or path length. Moreover, by means of the described restoring-torque-generating device 110, the steering device 100 permits a space-saving construction in the axial direction of the shaft 130, which can furthermore be implemented with simple structural elements. Here, a steering torque determined by means of the sensor 160 or a correspondingly determined restoring torque permits, for example in conjunction with a steer-by-wire steering system, the generation of a control signal to one or more steering actuators on the basis of the sensor signal.

The steering device 100 can advantageously be used with a steer-by-wire steering system to set a torque which is directed counter to the rotation of a steering handle of a motor vehicle, i.e. a restoring torque. When setting such a restoring torque, a basic restoring torque or basic resistance torque is the torque resulting from frictional resistances between the engaged components of the transmission and in the mounting thereof as well as from frictional resistances during the movement of other components. The basic restoring torque changes over the operating time of a steering device, depending on various factors, such as lubrication or wear. It must therefore be determined regularly, e.g. when starting the vehicle, by a defined activation of the restoring-torque-generating device and thus updated.

However, during operation of a steer-by-wire steering system, it is necessary to impart to the vehicle driver, via the steering handle, restoring torques which differ from the basic restoring torque, depending on the current driving conditions, wherein a mean restoring torque of 2 to 3 Nm is preferably imparted to the vehicle driver. If the necessary restoring torque exceeds the basic restoring torque, the drive and the transmission are used to generate a torque which poses a greater resistance to a steering movement initiated by the vehicle driver to change the direction of travel. If the necessary restoring torque is less than the basic restoring torque, the drive and the transmission are used to generate a torque which assists the change in the direction of travel initiated by the vehicle driver, that is to say acts on the steering handle in the same direction of rotation as the vehicle driver when initiating the change in the direction of travel.

In order to minimize operating noises, the restoring-torque-generating device is furthermore expediently controlled in such a way that the stop element does not strike the stops fixed with respect to the vehicle, or strikes them only at a low speed, in order to limit a rotation of the housing or of the shaft of the restoring-torque-generating device about the axis of rotation of the shaft. In cooperation with the elastic element, this is accomplished by generating a torque which is opposite to the direction of rotation of the steering handle and which brakes or prevents further rotation.

FIG. 2 shows a detail view of the restoring-torque-generating device 110 of the steering device 100 in FIG. 1. Here, identical reference signs designate identical features. In FIG. 2, it can be seen that, in the example shown, the shaft 130 ends in the housing 112. Arranged beneath the housing 112, as an extension of the shaft 130, is a shaft stub 132, which is connected to the housing 112 for conjoint rotation therewith. The shaft stub 132 serves as a support for the housing 112 in the direction of the axis of rotation of the shaft 130 and is in this case mounted rotatably with respect to the support element 104, in the present case on the carriage, in such a way that it permits a rotation of the housing 112 about the axis of rotation of the shaft 130 independently of a rotation of the shaft 130, e.g. as a result of an actuation of the drive 120.

FIG. 3 shows schematically and by way of example a steering device 300 according to another example. Unless otherwise stated in the following, what has been said in connection with steering device 100 applies correspondingly with respect to the features of the steering device 300 and its functionality. As a departure from the steering device 100, the housing 312 in the example shown in FIG. 3 is arranged below the supporting element 304, wherein the shaft 330, which is connected to a steering handle, projects completely through the supporting element 304. Likewise deviating from the steering device 100 is the arrangement of the supporting element 304 in a manner such that it is fixed with respect to the vehicle and immovable.

Moreover, restoring-torque-generating device 310 differs from restoring-torque-generating device 110 in that an elastic element 340 is arranged simultaneously as a stop element for limiting a rotation of the restoring-torque-generating device 310 between two stops 350, 352. On the other hand, a projection 314 of the housing 312 serves only for fastening the sensor 360 to the housing and for supporting the restoring-torque-generating device 310 against a rotation with respect to the supporting element 304 via the sensor 360 and the elastic element 340.

FIG. 4 shows schematically and by way of example another example of a steering device 400. The steering device 400 represents a modification of the steering device 300 in FIG. 3. Unless otherwise stated in the following, what has been said in connection with FIG. 3 applies correspondingly to the steering device 400.

As a departure from the example in FIG. 3, the restoring-torque-generating device 410 of the steering device 400 further comprises a damping element 470 for damping a rotation of the restoring-torque-generating device 410 about the axis of rotation with respect to the supporting element with the interposition of the elastic element. In the example shown, the restoring-torque-generating device 410 furthermore comprises a force-transmitting element 472 for supporting the restoring-torque-generating device 410 with respect to the supporting element via the elastic element. In conjunction with corresponding stops, a rotation of the restoring-torque-generating device 410 about the axis of rotation of the shaft is in this way limited.

In some examples, the damping element 470 further comprises a force or displacement sensor. In further examples, a force or displacement sensor is provided as part of the force transmission element 472.

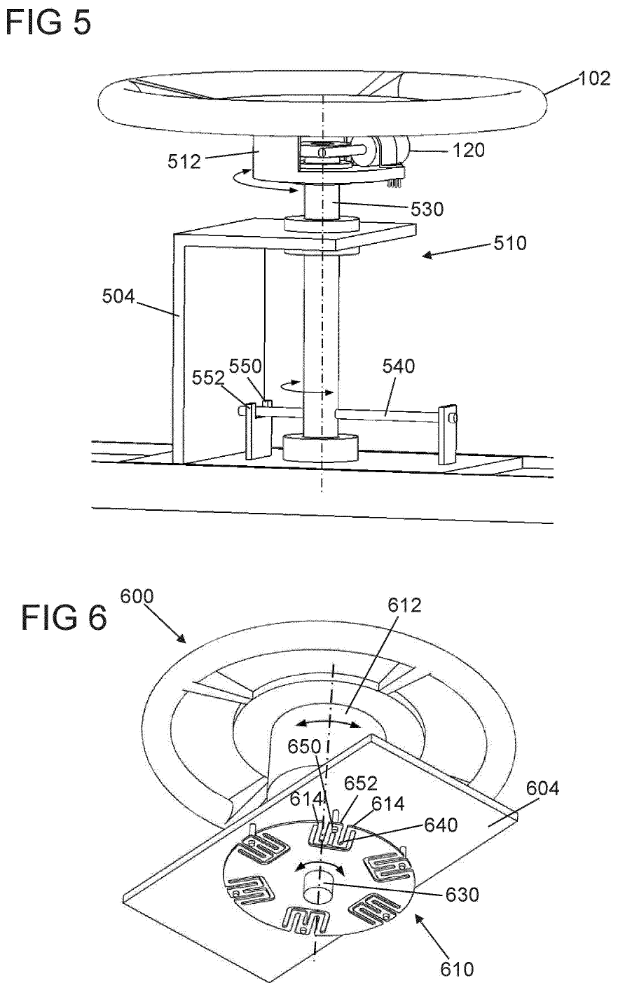

FIG. 5 shows schematically and by way of example a steering device 500 according to another example. Unless otherwise stated in the following, what has been said above applies correspondingly to the steering device 500.

In the case of the steering device 500, in contrast to the preceding examples, the restoring-torque-generating device 510 is supported in relation to the supporting element 504 with respect to a rotation about the axis of rotation not via the housing 512, but via the shaft 530.

In the case of the steering device 500, the housing 512 is connected to the steering handle 102 for conjoint rotation therewith. A torque generated by the drive 120 thus acts on the steering handle 102 via the housing 512, and not, as in the previous examples, via the shaft 530.

The supporting element 504 largely corresponds to the supporting element 104 in FIG. 1. For support against a rotary motion, the restoring-torque-generating device 510 comprises a bending bar 540 as an elastic element. The bending bar 540 extends through the shaft 530, intersecting the axis of rotation in the radial direction, for example. One end of the bending bar 540 is connected to the supporting element 504 in a fixed location with respect to the supporting element 504. An opposite free end of the bending bar 540 is movable, such that a rotation of the shaft 530 leads to bending of the bending bar 540 and, in the process, to a movement of the free end of the bending bar 540. A movement of the free end of the bending bar 540, and thus also a rotation of the shaft 530, is limited by the stops 550, 552 between which the free end of the bending bar 540 is arranged. Here, the free end of the bending bar 540 serves as a stop element of the restoring-torque-generating device 510.

In further examples, the bending bar 540 has no free end, but extends fully between the shaft 530 and the fixed connection of the bending bar 540 to the supporting element 504. In this case, stops 550, 552 are arranged on both sides of the bending bar, for example, in order to limit bending of the bending bar 540 as a result of rotation of the shaft 530.

In further examples, the restoring-torque-generating device 510 is additionally supported with respect to the supporting element 504 with the interposition of a force or displacement sensor.

In general, the techniques described here are suitable for use both with a force sensor and with a displacement sensor for determining a restoring torque. For example, on the basis of a known displacement-force characteristic of the elastic element, an association is provided here between the extent of a steering movement and a restoring torque to be generated by the drive of the restoring-torque-generating device, which counteracts the steering movement, for example that of a driver of a motor vehicle. The techniques described here are thus suitable for use with any sensor arrangement which allows conclusions to be drawn as to the magnitude of a steering movement at the steering handle or of a steering torque.

FIG. 6 shows schematically and by way of example a steering device 600 according to another example. Unless otherwise stated in the following, what has been said in connection with FIG. 5 applies correspondingly to the steering device 600. In particular, similarly to the example from FIG. 5, in the case of the steering device 600, the housing 612 of the restoring-torque-generating device 610 is connected to the steering handle for conjoint rotation therewith, and the restoring-torque-generating device 610 is supported in relation to the supporting element 604 with respect to a rotation about the axis of rotation via the shaft 630.

As a departure from the preceding examples, the supporting element 604 does not include a support section for supporting the shaft 630 at an end of the shaft 630 adjacent to the steering handle. As in the example of FIG. 5, the shaft 630 of the restoring-torque-generating device 610 is rotatably mounted in the housing 612 and on the supporting element 604, projecting through the supporting element 604 in FIG. 6. The restoring-torque-generating device 610 is supported underneath the supporting element 604 by means of a flat spring, which in the example shown is of circular disk-shaped design. The flat spring is connected to the shaft 630 for conjoint rotation therewith. Moreover, bending segments 640 as elastic elements of the flat spring are non-rotatably fixed to the supporting element 604 or the integral components thereof.

The elasticity of the flat spring in the region of the bending segments 640 permits rotary movements of the shaft 630 with bending of the bending segments 640. The rotation of the restoring-torque-generating device 610 is likewise limited by means of the flat spring due to its shape in the region of the bending segments 640. In the region of the bending segments 640, the flat spring has slots by means of which bending of the bending segments 640 is made possible and, at the same time, is limited according to a width of the slots. In the example shown, sections of the flat spring on both sides of a fixing on the supporting element 604 act here as stops 650, 652. These regions limit the bending of the flat spring in the direction of rotation by contact with regions 614 of the flat spring which lie opposite the stops 650, 652 at a respective slot. The elasticity and deformation behavior of the flat spring can be determined, for example, by the number and configuration of the bending segments 640.

In other examples of the steering device 600, the restoring-torque generating device 610 is supported on a support section of the supporting element 604, on a carriage, or on some other suitable structure.

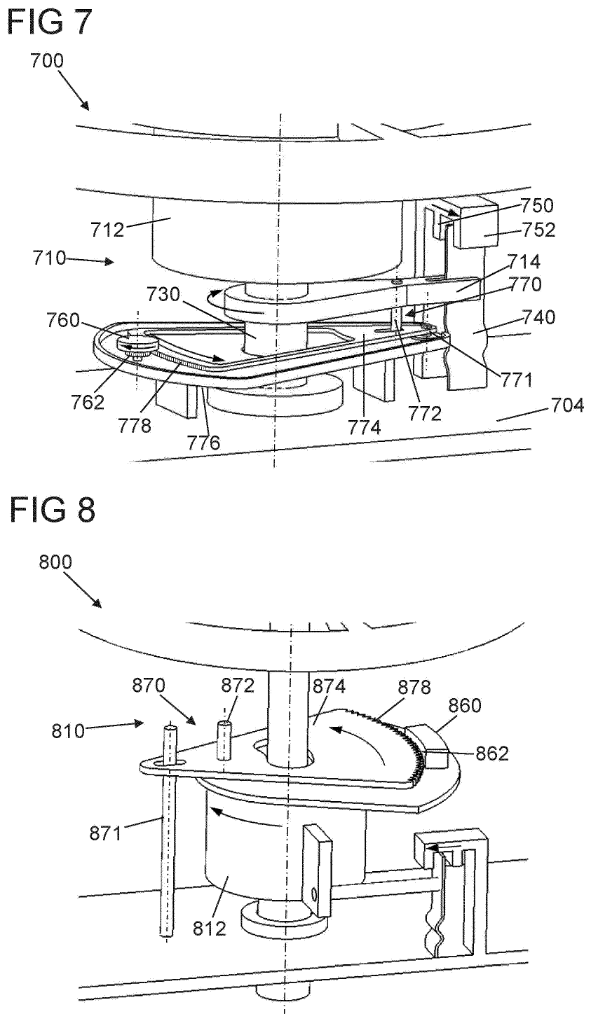

FIG. 7 shows schematically and by way of example a steering device 700 according to another example. Unless otherwise stated in the following, what has been said in connection with FIGS. 5 and 6 applies correspondingly to the steering device 700. In particular, in the case of the steering device 700 too, the housing 712 is connected to the steering handle for conjoint rotation therewith, and the restoring-torque-generating device 710 is supported in relation to the supporting element 704 with respect to a rotation about the axis of rotation via the shaft 730.

The restoring-torque-generating device 710 comprises a rigid lever 714 for support with respect to the supporting element 704, which lever is connected to the shaft 730 for conjoint rotation therewith. The free end of the rigid lever 714 engages for support around the elastic element 740, the deformation of which and thus also the rotation of the restoring-torque-generating device 710 is once again limited by stops 750, 752.

A steering movement or a rotation of the shaft 730 is detected by means of a rotating angle sensor 760, which is arranged in a housing 776 (shown open here). Here, the housing 776 is secured on the supporting element 704 in a fixed location with respect to the latter.

When the shaft 730 is rotated, a driver 772 arranged on the rigid lever 714 is moved in the direction of rotation together with said lever. Here, the driver 772 is part of a lever arrangement 770 in which a movement of the driver 772 acts on a sensor lever 774. The sensor lever 774 is pivotable about a lever axis of rotation 771 with respect to the sensor housing 776. When the shaft 730 is rotated, for example clockwise, the driver 772 also moves clockwise about the axis of rotation of the shaft 730. An axis of rotation 771 of the sensor lever 774 is arranged opposite the shaft 730 with respect to the driver 772 and in a fixed location with respect to the supporting element 704. In the example shown, this arrangement causes the sensor lever 774 to move counterclockwise about its axis of rotation 771 (arrows on the rigid lever 714 and on the sensor lever 774). Here, pivoting the sensor lever 774 causes a movement of an outer circular arc section of the sensor lever 774 relative to the angle sensor 760. In this arrangement, toothing 778 engages in a toothed rim 762 of the angle sensor 760, with the result that the sensor 760 is set in rotation when the sensor lever 774 is pivoted. An angle of rotation of the shaft 730 can thus be determined in accordance with the rotation of the sensor 760.

The lever arrangement 770 effects a conversion of a rotary motion of the shaft 730 to larger angular movements of the sensor 760. This permits a higher measuring accuracy of a change in the angle of the restoring device 710.

FIG. 8 shows schematically and by way of example a steering device 800 according to another example. As a departure from the example in FIG. 7, in the case of the steering device 800, the restoring-torque-generating device 810 is supported not via the shaft, but via the housing 812, similarly to the examples described in FIGS. 3 and 4. Moreover, steering device 800 comprises a lever arrangement 870 for detecting an angle of rotation about the axis of rotation of the restoring-torque-generating device 810, similarly to the example in FIG. 7.

As a departure from the example in FIG. 7, in the case of the restoring-torque-generating device 810, the sensor 860 is connected to the housing 812 for conjoint rotation therewith. A rotation of the housing 812 about its axis of rotation thus brings about a movement of the lever axis of rotation 872 in the same direction. In cooperation with the guide 871, which is arranged in a fixed location with respect to the supporting element, this causes a rotation of the sensor lever 874 in the opposite direction about the lever axis of rotation 872.

As with the example in FIG. 7, the sensor lever 874 too comprises toothing 878 on an outer circular arc section. As a departure from the sensor 760, however, the toothing on the sensor 860 does not serve to drive a rotating angle sensor. Instead, the sensor 860 is designed as an optical sensor. Here, the toothing 878 serves as an optical marking for scanning by an optical element 862 of the sensor 860.

FIG. 9 shows schematically and by way of example a restoring-torque-generating device 910 according to another example. The restoring-torque-generating device 910 is a modification of the device shown in FIG. 8. In the example shown, toothing 978 serves to drive a rotating angle sensor 960. In this case, the toothing 978 engages in a toothed rim 962 of the sensor 960, similarly to the example in FIG. 7.

FIG. 10 shows schematically and by way of example a restoring-torque-generating device 1010 according to another example. Unless otherwise stated in the following, what has been said in connection with FIG. 9 applies correspondingly to the restoring-torque-generating device 1010.

As a departure from the preceding examples, the restoring-torque-generating device 1010 comprises a lever arrangement 1070 in the form of a two-lever arrangement. In this case, a rotating angle sensor 1060 is arranged on a sensor lever 1084, and toothing 1078 cooperating with the sensor 1060 is arranged on a transmitter lever 1074. The lever arrangement 1070 is designed in such a way that rotation of the shaft 1030 leads to the pivoting of the transmitter lever 1074 and sensor lever 1084 in opposite directions.

The lever arrangement 1070 is guided by means of a fixing structure 1080 which is fixed with respect to the supporting element. For this purpose, the fixing structure 1080 comprises a transmitter lever fixing 1071 and a sensor lever fixing 1082. The transmitter lever fixing 1071 and the sensor lever fixing 1082 are arranged on opposite sides of an axis of rotation 1072 which is fixedly connected to the sensor housing 1076 and which serves as an axis of rotation both for the sensor lever 1084 and for the transmitter lever 1074, wherein the sensor housing 1076 in turn is connected to the housing 1012 of the restoring-torque-generating device 1010 for conjoint rotation with said housing. Here, the opposite arrangement of the fixings 1071 and 1082 with respect to the axis of rotation 1072 causes the transmitter lever 1074 and sensor lever 1084 to pivot in opposite directions relative to their fixings 1071, 1082 when the axis of rotation 1072 moves. In this case, the movement of the sensor lever 1084 corresponds substantially to the movement of the sensor lever 874 in FIG. 8. In contrast, the end of the transmitter lever 1074 on which the toothing 1078 is arranged is pivoted in the opposite direction about the transmitter lever fixing 1071 by virtue of the described arrangement and thus drives the rotating angle sensor 1060 by engagement in the toothed rim 1062.

In order to compensate for a change in the distances between the axis of rotation 1072 and each of the fixings 1071, 1082 resulting from movement of the axis of rotation 1072, both the transmitter lever 1074 and the sensor lever 1084 have a respective elongate hole in the region of their fixings 1071, 1082.

FIG. 11 shows an enlarged illustration to illustrate the arrangement of the individual features of the lever arrangement 1070 as well as the respective pivoting behavior of the sensor lever 1084 and transmitter lever 1074 during a movement of the axis of rotation 1072 as a result of a rotation of the restoring-torque-generating device 1010 about the axis of rotation of the shaft 1030.

Compared to the lever arrangements in FIGS. 8 and 9, the two-lever arrangement 1070 causes a greater movement of the toothing 1078 and the angle sensor 1060 with respect to one another. This causes a further increase of the change in the angle of the angle sensor 1060 during a given rotation of the restoring-torque-generating device 1010 about the shaft 1030. This in turn permits an increased measuring accuracy of changes in the angle at the restoring-torque-generating device 1010.

Both elastic elements and stops and damping elements of the embodiments of a restoring-torque-generating device have been described above as separate elements. It is pointed out that this is to be understood by way of example and has been chosen as a means for better illustration of the necessary functionalities in the implementation of the support of the restoring-torque-generating devices with respect to the motor vehicle against a rotation about the axis of rotation of the shaft. The elastic or damping support and the limitation of the rotation can likewise be integrated into other components of the restoring-torque-generating device.

In the embodiment in FIG. 1, for example, it is possible for the use of the elastic element 140 to be dispensed with and, instead, for the restoring-torque-generating device 110 to be supported via the force sensor 160 on a rigid element against a rotation about the axis of rotation of the shaft 130 with respect to the motor vehicle. In this case, the function of the elastic element 140 is fulfilled by the inherent elasticity of the force sensor 160. It is also possible to dispense with the fixed stops 150, 152 and instead to generate a restoring torque at a level which acts as a stop and limits a rotation about the axis of rotation of the shaft.

The restoring-torque-generating device has been described for generating a torque which is directed counter to a rotation of a steering handle of a motor vehicle in connection with steer-by-wire steering systems. However, applications are also conceivable in which a torque is generated which assists the rotation of a steering handle of a motor vehicle, or in which a torque is generated without the action of the driver of the vehicle.

FIG. 12 shows schematically and by way of example a segment of a steering device 1200 according to another example. Steering device 1200 represents a modification of the steering device 100 in FIGS. 1 and 2. As a departure from the steering device 100, elastic elements 1202, 1204 are arranged between the stop element 114 and each of the stops 150, 152. When the steering device 1200 is deflected by rotation about the axis of rotation, the elastic elements 1202, 1204 exert a restoring force on the stop element 114. In some examples, the elastic elements 1202, 1204 are provided in addition to the elastic element 140. In other examples, the elastic elements 1202, 1204 replace the elastic element 140 of the steering device 100. In these embodiments, the sensor 160 is, for example, supported non-elastically with respect to the supporting element 104. In some examples, moreover, only one of the elastic elements 1202, 1204 is provided, exerting a corresponding restoring force when the steering device is deflected in any direction.

In some examples of the steering device 1200, the elastic elements 1202, 1204 are designed in such a way that they each counteract only a rotation of the steering handle in one direction. For example, each of the elastic elements 1202, 1204 is arranged between the stop element 114 and the respective stop 150, 152 in such a way that it can be deformed relative to the starting position only by compression or counteracts only compression. Moreover, in some of these examples, one or more of the elastic elements 1202, 1204 have a progressive force-displacement characteristic. In the example shown, this can be achieved, for example, by suitable winding of spiral spring elements 1202, 1204.

The above-described provision of additional or alternative elastic elements 1202, 1204 can also be used in corresponding fashion in modified examples of the above-described steering devices according to FIGS. 3-11.

FIG. 13 shows schematically and by way of example another example of a steering device 1300. Steering device 1300 represents a modification of the steering device 800 in FIG. 8. In the case of the steering device 1300, the sensor lever 1374 has a circular ring segment of a multipole magnet arrangement 1378 in an edge region, instead of toothing, for detecting a deflection. The multipole magnet arrangement 1378 comprises an arrangement of different magnet poles alternating in each case. Here, the angle of rotation is detected by an associated magnetic sensor 1360.

The production of the sensor lever 1374 with a magnetizable region in the circular arc section is possible by means of a two-component injection molding process, for example. A pole width of up to 1 mm, i.e. a width of north and south poles of 0.5 mm each, can be achieved here.

FIG. 14 shows schematically and by way of example a steering device 1400 according to another example. The steering device 1400 represents a modification of the steering device 1300 in FIG. 13. Similarly to the steering device 1300, steering device 1400 comprises a magnetic region in a circular arc section of the sensor lever 1474, and the angle of rotation is detected by means of a magnetic sensor 1460. In the case of the steering device 1400, however, the magnetic arc section is not designed as a permanent magnet, but as a thin-walled electromagnet 1478. The magnetic sensor 1460 furthermore has a slot-shaped, curved sensor receptacle 1462. The electromagnet 1478 is movably accommodated in the sensor receptacle 1462, which at the same time forms a sensor field for movements of the electromagnet 1478.

The electromagnet 1478 can be supplied with electric current via power supply means (not shown). This is provided, for example, by a power supply unit of the motor vehicle in which the steering device 1400 is installed. The production of the sensor lever 1474 is again possible by the two-component injection molding process.

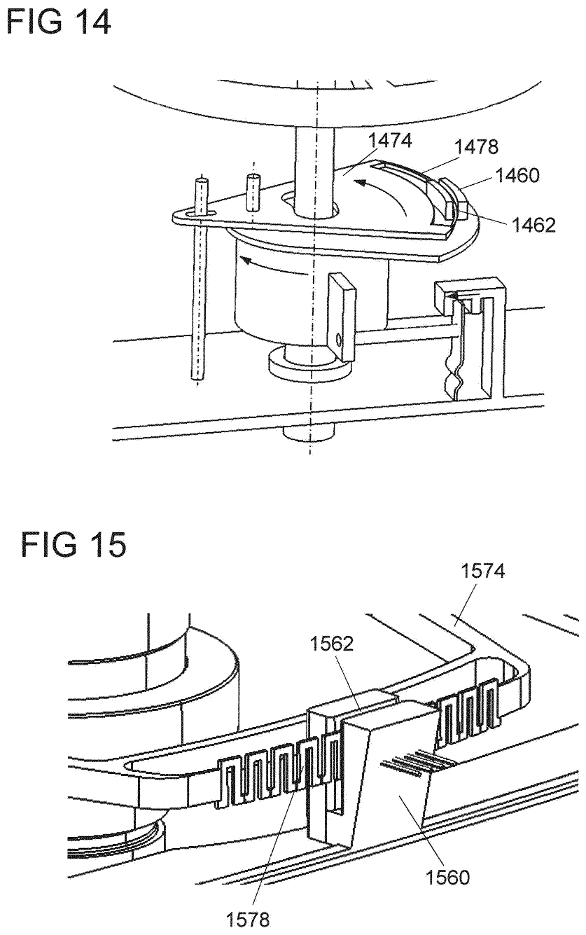

FIG. 15 shows a detail view of an arrangement of a magnetic sensor 1560 with sensor receptacle 1562 and of an electromagnet 1578 movably arranged therein, which is designed as a thin-walled electromagnet in the edge region of a circular arc section of the sensor lever 1574. The sensor lever 1574 and the magnetic sensor 1560 are, for example, similar configurations of the corresponding components shown in FIG. 14.

The electromagnet 1578 is designed as a wave-shaped conductor track. A suitable conductor track can be designed, for example, as a flex cable which is clamped in the sensor lever, as a stamped grid injected into the sensor lever, or as a wire wound on a carrier material similarly to a motor winding, or in other possible ways.

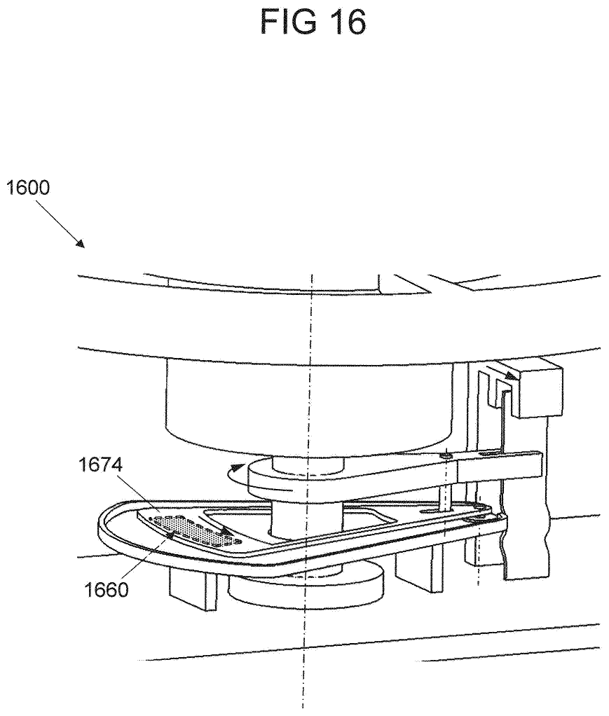

FIG. 16 shows schematically and by way of example a steering device 1600 according to another example. Steering device 1600 represents a modification of the steering device 700 in FIG. 7. Instead of the toothing 778 and a sensor 760 cooperating therewith and having a toothed rim 762 as shown in FIG. 7, steering device 1600 provides for the detection of an angle of rotation on the basis of an eddy current. For this purpose, steering device 1600 comprises an eddy current sensor 1660, which is arranged in a fixed location below the sensor lever 1674. When the sensor lever 1674 is rotated, an electrically conductive region of the sensor lever 1674 moves at least partially in the sensor field of the eddy current sensor 1660. On the basis of eddy current generated during this process, the movement of the sensor lever 1674 is detected by means of the eddy current sensor 1660.

1. A restoring-torque-generating device for generating a torque which is directed counter to a rotation of a steering handle of a motor vehicle, having
a housing,
a drive, which is arranged in a fixed location in the housing,
a transmission, which is in engagement with the drive, and
a shaft, which is mounted in the housing and is connected to a component of the transmission for conjoint rotation therewith,
wherein the shaft or the housing is designed to be connected to the steering handle for conjoint rotation therewith, and the housing, the transmission and the shaft are designed for rotatable mounting with respect to the motor vehicle and about an axis of rotation of the shaft,
characterized by
at least one elastic element, wherein the restoring-torque-generating device is designed to be supported with respect to the motor vehicle against a rotation about the axis of rotation of the shaft with the interposition of the elastic element.

2. The restoring-torque-generating device as claimed in claim 1, characterized in that the support with respect to the motor vehicle is accomplished via the housing or the shaft.

3. The restoring-torque-generating device as claimed in claim 1, characterized by at least two stops for arrangement in a manner fixed with respect to the vehicle, which are designed to limit a rotation of the housing or of the shaft about the axis of rotation of the shaft.

4. The restoring-torque-generating device as claimed in claim 3, characterized in that the stops limit the rotation to less than a quarter of a revolution.

5. The restoring-torque-generating device as claimed in claim 3, characterized in that the stops are designed to effect limitation of the rotation by contact with the elastic element.

6. The restoring-torque-generating device as claimed in claim 3, characterized by at least one stop element which is arranged for conjoint rotation with respect to the housing or the shaft and is designed to contact in each case one of the stops in order to limit the rotation.

7. The restoring-torque-generating device as claimed in claim 1, characterized in that the transmission is designed as a worm gear which comprises at least one worm shaft and at least one worm wheel.

8. The restoring-torque-generating device as claimed in claim 1, characterized by at least one damping element, wherein the restoring-torque-generating device is designed to be supported against rotation about the axis of rotation of the shaft, furthermore with the interposition of the damping element.

9. The restoring-torque-generating device as claimed in claim 1, characterized by at least one sensor, which is designed for detecting a force and/or for detecting an angle of rotation about the axis of rotation of the shaft.

10. The restoring-torque-generating device as claimed in claim 9, characterized in that at least one sensor of the restoring-torque-generating device is designed to detect a force, and the restoring-torque-generating device is designed to be supported against a rotation about the axis of rotation of the shaft, furthermore with the interposition of the sensor.

11. he restoring-torque-generating device as claimed in claim 10, characterized in that the elastic element of the restoring-torque-generating device is integrated in the sensor for detecting the force.

12. The restoring-torque-generating device as claimed in claim 9, characterized in that the restoring-torque-generating device comprises a plurality of sensors, of which at least one first sensor is designed for detecting a force and at least one second sensor is designed for detecting an angle of the rotation about the axis of rotation of the shaft.

13. The restoring-torque-generating device as claimed in claim 9, characterized in that at least one sensor of the restoring-torque-generating device is acted upon via a lever arrangement.

14. The restoring-torque-generating device as claimed in claim 13, characterized in that the at least one sensor is designed for detecting an angle of rotation about the axis of rotation of the shaft and comprises at least one of a rotating angle sensor, an optical sensor, an eddy-current sensor and a magnetic sensor, which is designed for detecting a permanent or electrically generated magnetic field.

15. The restoring-torque-generating device as claimed in claim 13, characterized in that at least one lever of the lever arrangement is arranged for conjoint rotation with respect to the housing or the shaft.

16. The restoring-torque-generating device as claimed in claim 13, characterized in that at least one lever of the lever arrangement is embodied as a lever of the first class.

17. A steering device for arrangement in the motor vehicle, comprising:
the restoring-torque-generating device as claimed in claim 1, and
a supporting element,
wherein the shaft or the housing of the restoring-torque-generating device is connected to the steering handle for conjoint rotation therewith, and the restoring-torque-generating device is designed to be supported with respect to the supporting element against a rotation about the axis of rotation of the shaft.

18. A motor vehicle, comprising the restoring-torque-generating device as claimed in claim 1.

19. A motor vehicle, comprising the steering device as claimed in claim 17.
